(19) United States
(12) Patent Application Publication
(10) Pub. No.: US 2016/0358579 A1
(43) Pub. Date: Dec. 8, 2016

(54) A VOLTAGE COMPENSATION METHOD, A VOLTAGE COMPENSATION DEVICE AND A DISPLAY DEVICE

(71) Applicants: HEFEI BOE OPTOELECTRONICS TECHNOLOGY CO., LTD., Anhui (CN); BOE TECHNOLOGY GROUP CO., LTD., Beijing (CN)

(72) Inventors: Donghui Wang, Beijing (CN); Jiacheng Huang, Beijing (CN); Lingling Liu, Beijing (CN)

(21) Appl. No.: 14/893,915

(22) PCT Filed: Jun. 3, 2015
(86) PCT No.: PCT/CN2015/080656

§ 371 Date: Nov. 24, 2015

(30) Foreign Application Priority Data
Dec. 30, 2014 (CN) 201410850559.3

(51) Int. Cl. G09G 3/36

(52) U.S. Cl. CPC G09G 3/3696; G09G 2320/041

(57) ABSTRACT

The present invention provides a voltage compensation method, a voltage compensation device and a display device, which solves the existing problem of inappropriate compensation caused by compensating the common electrode with a fixed compensation voltage. The voltage compensation method comprises: obtaining a current ambient temperature; determining a compensated common electrode voltage corresponding to the current ambient temperature based on the current ambient temperature; outputting the compensated common electrode voltage.

### FIELD OF THE INVENTION

The present invention relates to the field of display technology, particularly to a voltage compensation method, a voltage compensation device and a display device.

### BACKGROUND OF THE INVENTION

The liquid crystal display device uses a liquid crystal display panel to realize image display. The liquid crystal display panel generally uses row by row scanning to realize display. FIG. 1 is an equivalent circuit diagram of an existing liquid crystal display panel pixel unit. As shown in FIG. 1, the display panel comprises crisscross gate lines (Sn, Sn+1) and data lines (Dn, Dn+1). The gate lines and the data lines separate the display panel into a plurality of pixel units arranged in array. Each pixel unit comprises a thin film transistor (TFT) 10, a liquid crystal capacitance Clc, a storage capacitance Cst and a parasitic capacitance Cgs. The signals inputted to the gate line Sn and the data line Dn in the process of display are as shown in FIG. 2, the maximum voltage of the gate line Sn is the turn-on voltage Vgh of the thin film transistor, the minimum voltage of the gate line Sn is the turn-off voltage Vgl of the thin film transistor. Due to existence of the liquid crystal capacitance Clc, the storage capacitance Cst and the parasitic capacitance Cgs in the pixel unit, as shown in FIG. 2, a feed through voltage ΔVp will be generated between the data line Dn and the input signal Pn of the pixel electrode.

Specifically, the calculating formula of the feed through voltage is:

$$Δ Vp = \frac{Cgs ( Vgh - Vgl )}{Clc + Cst + Cgs}$$

Wherein ΔVp is the feed through voltage, Vgh is the turn-on voltage of the thin film transistor, Vgl is the turn-off voltage of the thin film transistor, Clc is the liquid crystal capacitance, Cst is the storage capacitance, Cgs is the parasitic capacitance. The feed through voltage is generally compensated through a common electrode in the prior art, i.e., performing voltage compensation to the voltage Vcom of the common electrode, to adjust it as Vcom′, wherein the compensation voltage is ΔVoffset, and the compensation voltage ΔVoffset is equal to the feed through voltage ΔVp.

The common electrode voltage is generally compensated with a fixed feed through voltage in the prior art. However, the turn-on voltage and the turn-off voltage of the thin film transistor may vary due to variation of the external temperature, hence, compensating the common electrode with a fixed feed through voltage may result in inappropriate compensation.

### SUMMARY OF THE INVENTION

The embodiment of the present invention provides a voltage compensation method, a voltage compensation device and a display device, which makes appropriate voltage compensation to the common electrode based on the ambient temperature.

In order to achieve the above purpose, the embodiments of the present invention adopt the following technical solutions:

On the one hand, an embodiment of the present invention provides a voltage compensation method, the method comprising:

obtaining a current ambient temperature;

determining a compensated common electrode voltage corresponding to the current ambient temperature based on the current ambient temperature;

outputting the compensated common electrode voltage.

On the other hand, an embodiment of the present invention provides a voltage compensation device, the voltage compensation device comprising:

a first obtaining unit for obtaining a current ambient temperature;

a first determining unit for determining a compensated common electrode voltage corresponding to the current ambient temperature obtained by the first obtaining unit based on the current ambient temperature;

an output unit for outputting the compensated common electrode voltage.

On a further aspect, an embodiment of the present invention provides a display device comprising any of the voltage compensation device provided by the embodiment of the present invention.

The embodiments of the present invention provide a voltage compensation method, a voltage compensation device and a display device. When compensating the common electrode, the current ambient temperature is obtained firstly, then the compensated common electrode voltage corresponding to the current ambient temperature is obtained and outputted based on the current ambient temperature. Namely, under different ambient temperatures, a compensated voltage corresponding to the current ambient temperature is outputted so as to compensate the feed through voltages under different temperatures through the common voltage.

### BRIEF DESCRIPTION OF THE DRAWINGS

In order to explain the technical solutions in the embodiments of the present invention or the prior art more clearly, the drawings to be used in description of the embodiments or the prior art will be introduced briefly next. Apparently, the drawings described below are only some embodiments of the present invention, the ordinary skilled person in the art, on the premise of not paying any creative work, can also obtain other drawings based on these drawings.

FIG. 1 is an equivalent circuit diagram of an existing liquid crystal display panel pixel unit;

FIG. 2 is a schematic view of generation of a feed through voltage;

FIG. 3 is a schematic view of a voltage compensation method provided by the embodiment of the present invention;

FIG. 4 is a schematic view of a lookup table provided by the embodiment of the present invention;

FIG. 5 is a schematic view of another voltage compensation method provided by the embodiment of the present invention;

FIG. 6 is a schematic view of another voltage compensation method provided by the embodiment of the present invention;

FIG. 7 is a schematic view of another voltage compensation method provided by the embodiment of the present invention;

FIG. 8 is a schematic view of another voltage compensation method provided by the embodiment of the present invention;

FIG. 9 is a schematic view of another voltage compensation method provided by the embodiment of the present invention;

FIG. 10 is a schematic view of a voltage compensation device provided by the embodiment of the present invention;

FIG. 11 is a schematic view of another voltage compensation device provided by the embodiment of the present invention;

FIG. 12 is a schematic view of a first determining unit provided by the embodiment of the present invention;

FIG. 13 is a schematic view of another first determining unit provided by the embodiment of the present invention;

FIG. 14 is a schematic view of another first determining unit provided by the embodiment of the present invention.

### DETAILED DESCRIPTION OF THE INVENTION

Next, the technical solutions in the embodiments of the present invention will be described clearly and completely with reference to the drawings in the embodiments of the present invention. Apparently, the embodiments described are only a part rather than all of the embodiments of the present invention. Based on the embodiments of the present invention, all of the other embodiments obtained by the ordinary skilled person in the art without paying any creative work belong to the protection scope of the present invention.

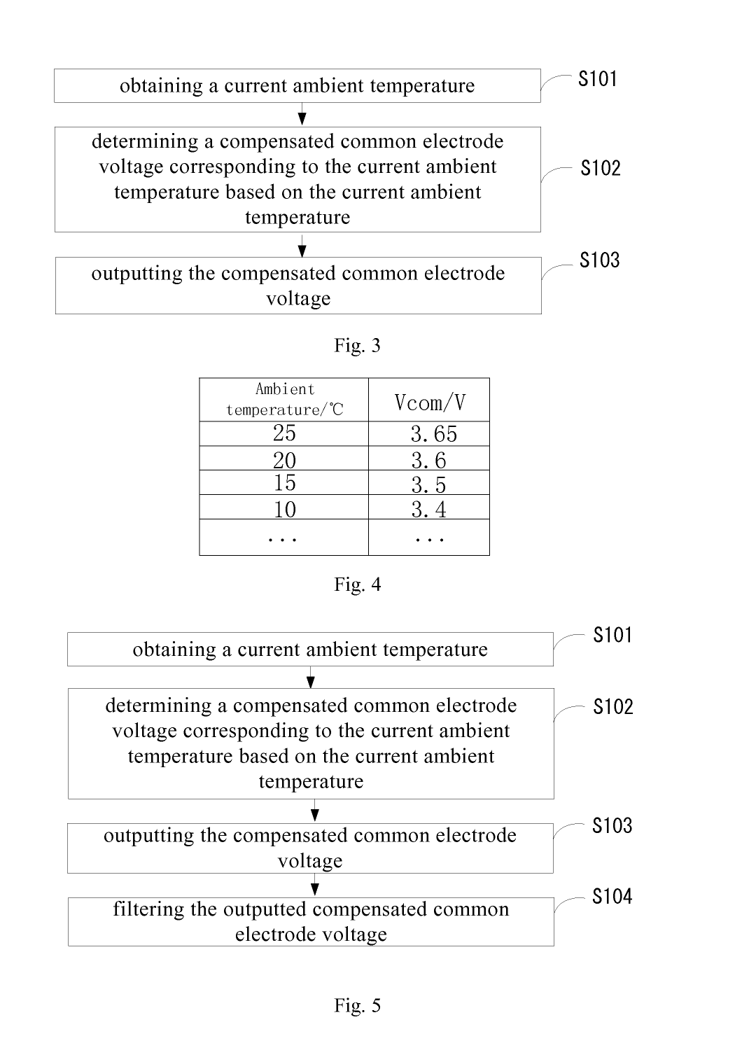

The embodiment of the present invention provides a voltage compensation method, as shown in FIG. 3, the method comprises:

Step 101, obtaining a current ambient temperature.

Specifically, a temperature sensor can be arranged in the display device to detect the current ambient temperature, so as to obtain the current ambient temperature through the temperature sensor.

Step 102, determining a compensated common electrode voltage corresponding to the current ambient temperature based on the current ambient temperature.

Specifically, preset relationships of different ambient temperatures obtained through experiments with the turn-on voltages of the thin film transistor and the turn-off voltages of the thin film transistor under the corresponding ambient temperatures can be formed, the compensated common electrode voltage corresponding to the current ambient temperature is determined based on the turn-on voltage of the thin film transistor and the turn-off voltage of the thin film transistor. Or, preset relationships of different ambient temperatures obtained through experiments with the common electrode compensation voltages under the corresponding ambient temperatures can be formed, the compensated common electrode voltage corresponding to the current ambient temperature is determined through the common electrode compensation voltage. Or, preset relationships of different ambient temperatures obtained through experiments with the compensated common electrode voltages under the corresponding ambient temperatures can also be formed, the compensated common electrode voltage corresponding to the current ambient temperature is determined through the lookup table.

As shown in FIG. 4, which is a lookup table formed by different ambient temperatures and the corresponding compensated common electrode voltages (Vcom). For example, the obtained current ambient temperature is 15° C., by looking up the lookup table, it is determined that the compensated common electrode voltage corresponding to the current ambient temperature is 3.5V.

Step 103, outputting the compensated common electrode voltage.

The embodiment of the present invention provides a voltage compensation method, when compensating the common electrode, the current ambient temperature is obtained firstly, then the compensated common electrode voltage corresponding to the current ambient temperature is obtained and outputted. Namely, under different ambient temperatures, a compensated voltage corresponding to the current ambient temperature is outputted so as to compensate the feed through voltages under different temperatures through the common voltage.

In one embodiment, the method further comprises: filtering the compensated common electrode voltage, so as to reduce noise and avoid interference. Specifically, filtering the compensated common electrode voltage can be either performed after step 102 and before step 103, or performed after step 103. As shown in FIG. 5, one embodiment of the present invention further comprises step 104 after step 103, which is specifically: filtering the outputted compensated common electrode voltage.

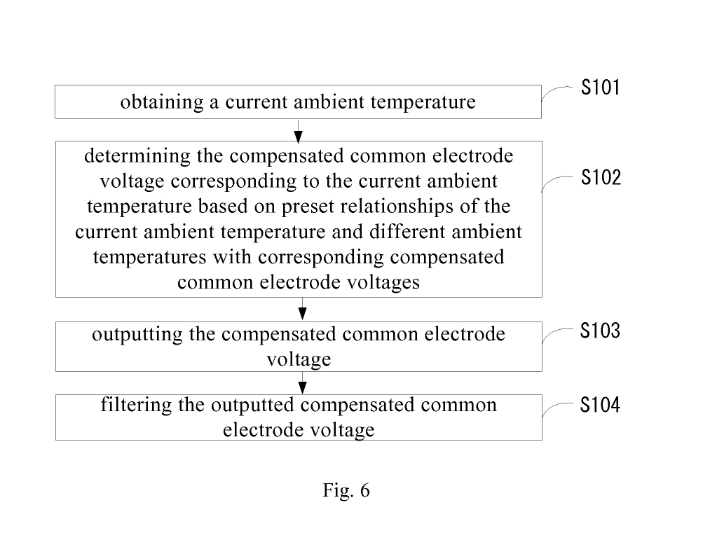

In one embodiment, as shown in FIG. 6, the step 102 is specifically: determining the compensated common electrode voltage corresponding to the current ambient temperature based on preset relationships of the current ambient temperature and different ambient temperatures with corresponding compensated common electrode voltages. That is, the preset relationships can be a lookup table formed by different ambient temperatures and corresponding compensated common electrode voltages. As shown in FIG. 4, the compensated common electrode voltage corresponding to the current ambient temperature can be determined by looking up the lookup table.

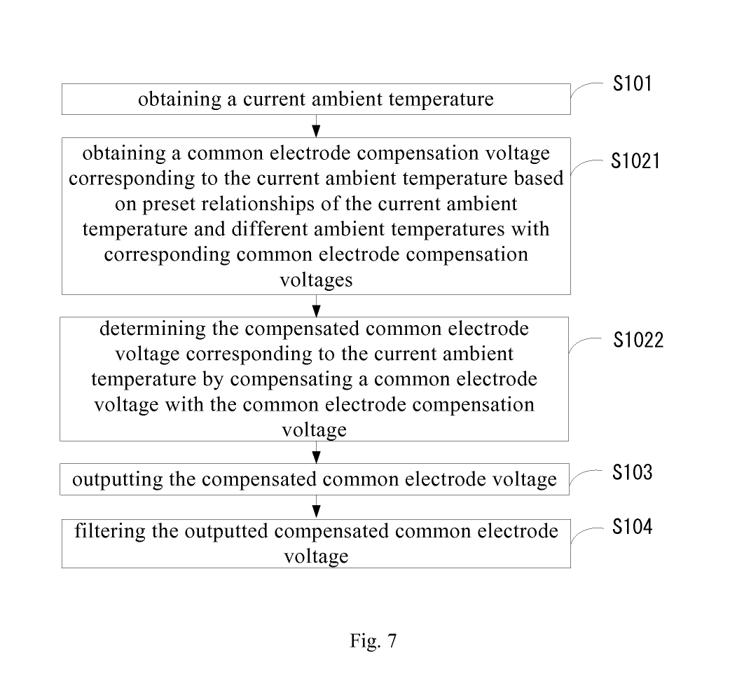

In one embodiment, as shown in FIG. 7, the step 102 comprises:

Step 1021, obtaining a common electrode compensation voltage corresponding to the current ambient temperature based on preset relationships of the current ambient temperature and different ambient temperatures with corresponding common electrode compensation voltages. The preset relationships can be a lookup table formed by different ambient temperatures and corresponding common electrode compensation voltages. The common electrode compensation voltage corresponding to the current ambient temperature can be determined by looking up the lookup table. That is, the common electrode compensation voltage is obtained by looking up the lookup table based on the current ambient temperature obtained by step 101. Specifically, the common electrode compensation voltage can be a feed through voltage under the current ambient temperature.

Step 1022, determining the compensated common electrode voltage corresponding to the current ambient temperature by compensating a common electrode voltage with the common electrode compensation voltage.

Specifically, compensating the common electrode voltage with the common electrode compensation voltage may be performing compensation calculation to the common electrode voltage based on the common electrode compensation voltage under the current ambient temperature, so as to determine the compensated common electrode voltage corresponding to the current ambient temperature.

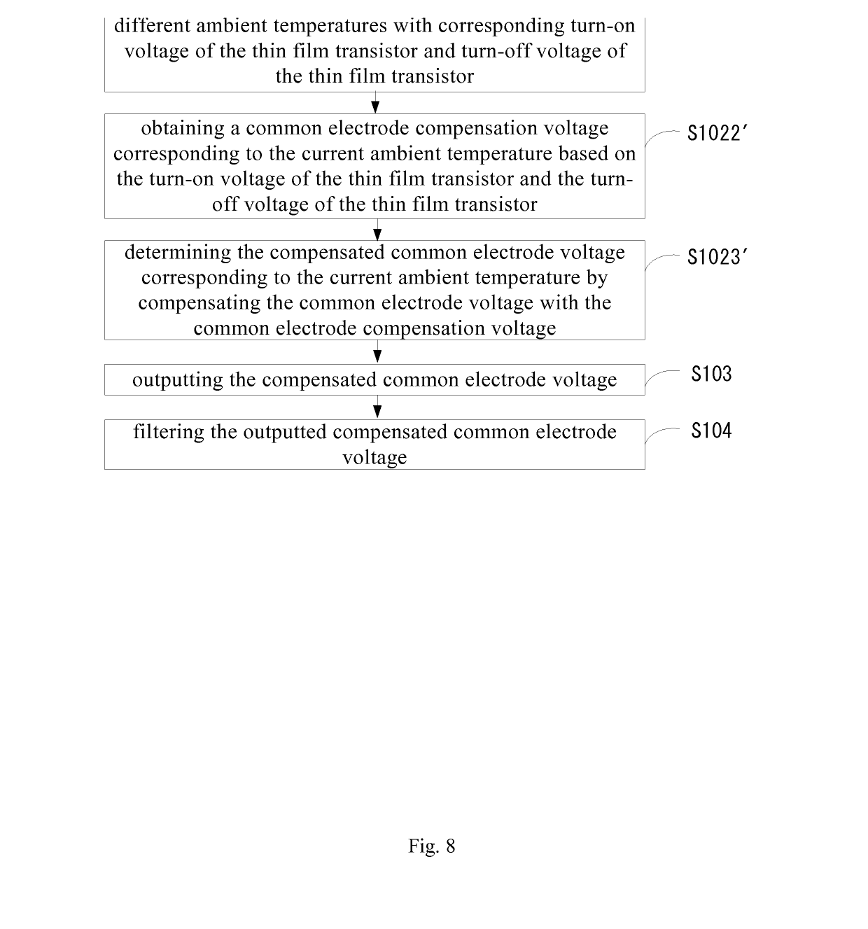

In one embodiment, as shown in FIG. 8, the step 102 specifically comprises:

Step 1021′, obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor. The preset relationships can be a lookup table formed by different ambient temperatures and corresponding turn-on voltages of the thin film transistor and turn-off voltages of the thin film transistor. The turn-on voltage of the thin film transistor and the turn-off voltage of the thin film transistor corresponding to the current ambient temperature can be determined by looking up the lookup table.

Step 1022′, obtaining a common electrode compensation voltage corresponding to the current ambient temperature based on the turn-on voltage of the thin film transistor and the turn-off voltage of the thin film transistor. The common electrode compensation voltage corresponding to the current ambient temperature can be determined through e.g. calculation specifically. For example, in the event that the liquid crystal capacitance (Clc), the storage capacitance (Cst), the parasitic capacitance (Cgs) have been known, and the common electrode compensation voltage ΔVoffset is equal to the feed through voltage ΔVp, the common electrode compensation voltage corresponding to the current ambient temperature can be obtained based on the calculation formula of the feed through voltage.

The calculation formula of the feed through voltage is:

$$Δ Vp = \frac{Cgs ( Vgh - Vgl )}{Clc + Cst + Cgs} = Δ Voffset$$

Certainly, it can also be obtained by forming a lookup table or by testing the flicker condition of the image. Or, the experimental data of the turn-on voltages of the thin film transistor and the turn-off voltages of the thin film transistor as well as the common electrode compensation voltage corresponding to different ambient temperatures obtained through experiments can also be formed into preset relationships (a lookup table), the common electrode compensation voltage corresponding to the current ambient temperature can be obtained by looking up the lookup table.

Step 1023′, determining the compensated common electrode voltage corresponding to the current ambient temperature by compensating the common electrode voltage with the common electrode compensation voltage. Specifically, compensating the common electrode voltage with the common electrode compensation voltage can be performing compensation calculation to the common electrode voltage based on the common electrode compensation voltage under the current ambient temperature, so as to determine the compensated common electrode voltage corresponding to the current ambient temperature.

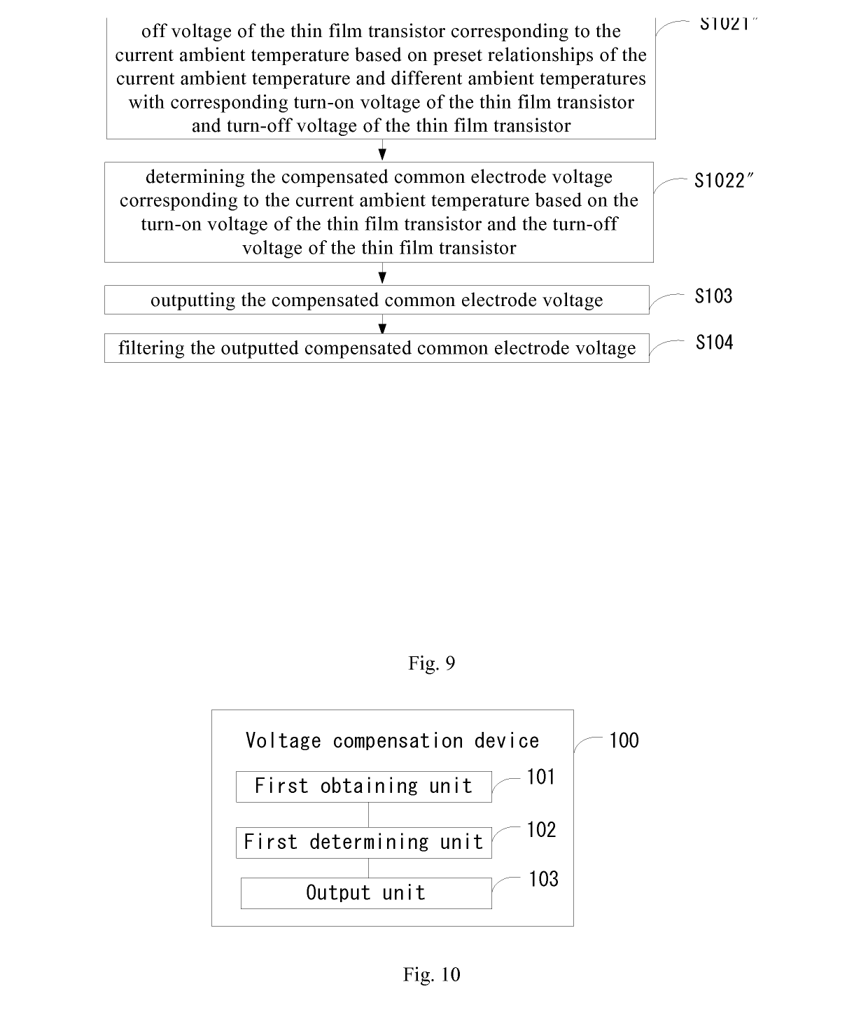

In one embodiment, as shown in FIG. 9, the step 102 specifically comprises:

Step 1021″, obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor. The preset relationships can be a lookup table formed by different ambient temperatures and corresponding turn-on voltages of the thin film transistor and turn-off voltages of the thin film transistor. The turn-on voltage of the thin film transistor and the turn-off voltage of the thin film transistor corresponding to the current ambient temperature can be determined by looking up the lookup table.

Step 1022″, determining the compensated common electrode voltage corresponding to the current ambient temperature based on the turn-on voltage of the thin film transistor and the turn-off voltage of the thin film transistor. Specifically, the compensated common electrode voltage corresponding to the current ambient temperature can be determined through calculation or based on the preset relationships of the turn-on voltage of the thin film transistor, the turn-off voltage of the thin film transistor and the compensated common electrode voltage.

To sum up, the embodiment of the present invention provides a voltage compensation method, to form the detection values of different ambient temperatures and the corresponding ambient temperatures into preset relationships, when compensating the common electrode, the current ambient temperature is obtained firstly, then the compensated voltage corresponding to the current ambient temperature is obtained and outputted through the preset relationships. Namely, under different ambient temperatures, the compensated voltage corresponding to the current ambient temperature is outputted so as to compensate the feed through voltage through the common voltage.

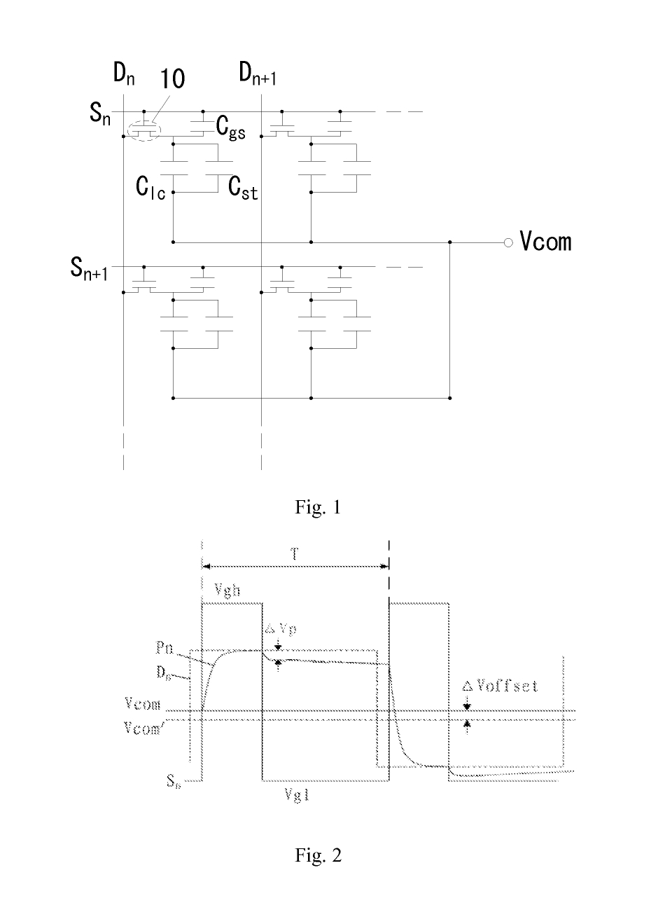

It should be noted that as shown in FIG. 2, since the feed through voltage is affected by various factors within one frame time T, it might not be a fixed value. An average value of the feed through voltage within one frame time can be determined so as to compensate the common electrode with the average value. The specific compensation method may make reference to the voltage compensation method of the common electrode provided by the embodiment of the present invention.

Next, the embodiment of the present invention provides a voltage compensation device corresponding to the above voltage compensation method. It should be noted that the respective function units contained by the following device may make reference to the corresponding steps in the above method, so the respective function units of the device in the following embodiments will not be described in detail.

The embodiment of the present invention provides a voltage compensation device 100, as shown in FIG. 10, the voltage compensation device 100 comprises:

A first obtaining unit 101 for obtaining an ambient temperature. Specifically, the current ambient temperature can be detected by a temperature sensor arranged in the display device, and the current ambient temperature can be obtained through the temperature sensor.

A first determining unit 102 for determining a compensated common electrode voltage corresponding to the current ambient temperature obtained by the first obtaining unit based on the obtained ambient temperature. Specifically, the first determining unit 102 may be a register.

Specifically, preset relationships of different ambient temperatures obtained through experiments with the turn-on voltages of the thin film transistor and the turn-off voltages of the thin film transistor under the corresponding ambient temperatures can be formed, the compensated common electrode voltage corresponding to the current ambient temperature is determined based on the turn-on voltage of the thin film transistor and the turn-off voltage of the thin film transistor. Or, preset relationships of different ambient temperatures obtained through experiments with the common electrode compensation voltages under the corresponding ambient temperatures can be formed, the compensated common electrode voltage corresponding to the current ambient temperature is determined through the common electrode compensation voltage. Or, preset relationships of different ambient temperatures obtained through experiments with the compensated common electrode voltages under the corresponding ambient temperatures can also be formed, the compensated common electrode voltage corresponding to the current ambient temperature is determined through the lookup table.

An output unit for outputting the compensated common electrode voltage. Specifically, the output unit 103 may be a multiplexer, the corresponding compensated voltage is outputted through the multiplexer.

In one embodiment, as shown in FIG. 11, the voltage compensation device 100 of the common electrode further comprises:

A filtering unit 104 for filtering the compensated common electrode voltage, so as to reduce noise and avoid interference.

In one embodiment, the first determining unit 102 is used for determining the compensated common electrode voltage corresponding to the current ambient temperature based on preset relationships of the current ambient temperature and different ambient temperatures with corresponding compensated common electrode voltages. That is, the preset relationships can be a lookup table formed by different ambient temperatures and the corresponding compensated common electrode voltages. The compensated common electrode voltage corresponding to the current ambient temperature can be determined by looking up the lookup table.

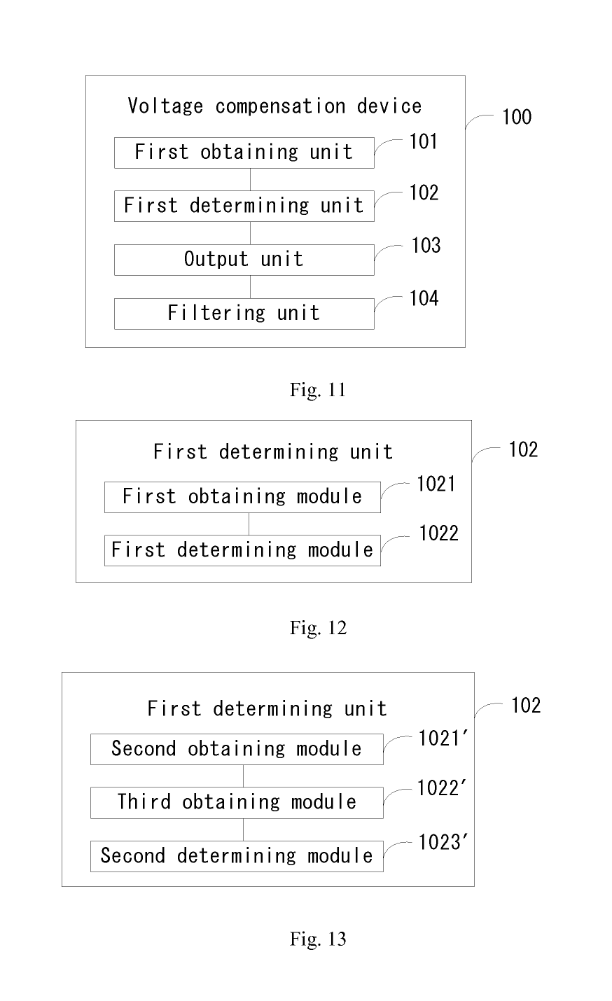

In one embodiment, as shown in FIG. 12, the first determining unit 102 specifically comprises:

A first obtaining module 1021 for obtaining a common electrode compensation voltage corresponding to the current ambient temperature based on preset relationships of the current ambient temperature and different ambient temperatures with corresponding common electrode compensation voltages. The preset relationships can be a lookup table formed by different ambient temperatures and the corresponding compensated common electrode voltages. The common electrode compensation voltage corresponding to the current ambient temperature can be determined by looking up the lookup table.

A first determining module 1022 for determining the compensated common electrode voltage corresponding to the current ambient temperature by compensating a common electrode voltage with the common electrode compensation voltage. Specifically, compensating the common electrode voltage with the common electrode compensation voltage may be performing compensation calculation to the common electrode voltage based on the common electrode compensation voltage under the current ambient temperature, so as to determine the compensated common electrode voltage corresponding to the current ambient temperature.

In one embodiment, as shown in FIG. 13, the first determining unit 102 specifically comprises:

A second obtaining module 1021′ for obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor. The preset relationships can be a lookup table formed by different ambient temperatures and corresponding turn-on voltages of the thin film transistor and turn-off voltages of the thin film transistor. The turn-on voltage of the thin film transistor and the turn-off voltage of the thin film transistor corresponding to the current ambient temperature can be determined by looking up the lookup table.

A third obtaining module 1022′ for obtaining a common electrode compensation voltage corresponding to the current ambient temperature based on the turn-on voltage of the thin film transistor and the turn-off voltage of the thin film transistor. The common electrode compensation voltage corresponding to the current ambient temperature can be determined through e.g. calculation.

In one embodiment, the third obtaining module is used for obtaining the common electrode compensation voltage corresponding to the current ambient temperature based on preset relationships of the turn-on voltage of the thin film transistor and the turn-off voltage of the thin film transistor with the common electrode compensation voltage.

A second determining module 1023′ for determining the compensated common electrode voltage corresponding to the current ambient temperature by compensating the common electrode voltage with the common electrode compensation voltage. Specifically, compensating the common electrode voltage with the common electrode compensation voltage can be performing compensation calculation to the common electrode voltage based on the common electrode compensation voltage under the current ambient temperature, so as to determine the compensated common electrode voltage corresponding to the current ambient temperature.

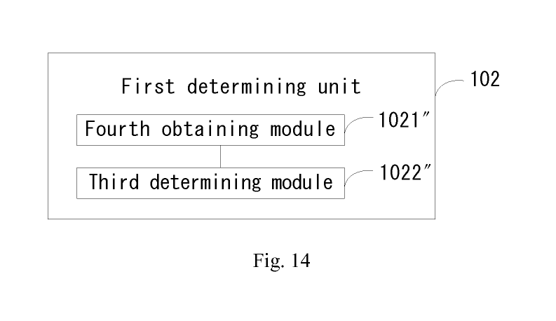

Or, in one embodiment, as shown in FIG. 14, the first determining unit 102 specifically comprises:

A fourth obtaining module 1021″ for obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor. The preset relationships can be a lookup table formed by different ambient temperatures and corresponding turn-on voltages of the thin film transistor and turn-off voltages of the thin film transistor. The turn-on voltage of the thin film transistor and the turn-off voltage of the thin film transistor corresponding to the current ambient temperature can be determined by looking up the lookup table.

A third determining module 1022″ for determining the compensated common electrode voltage corresponding to the current ambient temperature based on the turn-on voltage of the thin film transistor and the turn-off voltage of the thin film transistor. The compensated common electrode voltage corresponding to the current ambient temperature can be determined through e.g. calculation.

In one embodiment, the third determining module is used for determining the compensated common electrode voltage corresponding to the current ambient temperature based on preset relationships of the turn-on voltage of the thin film transistor and the turn-off voltage of the thin film transistor with the compensated common electrode voltage.

The embodiment of the present invention provides a display device comprising any of the voltage compensation devices provided by the embodiments of the present invention.

What are stated above are only specific implementing modes of the present invention, however, the protection scope of the present invention is not limited to this. Any skilled person familiar with the present technical field can easily think of modifications or replacements within the technical scope disclosed by the present invention. All of these modifications or replacements should be covered within the protection scope of the present invention. Therefore, the protection scope of the present invention should depend on the protection scopes of the claims attached therein.

1. A voltage compensation method, comprises:
obtaining a current ambient temperature;
determining a compensated common electrode voltage corresponding to the current ambient temperature based on the current ambient temperature;
outputting the compensated common electrode voltage.

2. The voltage compensation method according to claim 1, wherein the step of determining a compensated common electrode voltage corresponding to the current ambient temperature based on the current ambient temperature comprises:
determining the compensated common electrode voltage corresponding to the current ambient temperature based on preset relationships of the current ambient temperature and different ambient temperatures with corresponding compensated common electrode voltages.

3. The voltage compensation method according to claim 1, wherein the step of determining a compensated common electrode voltage corresponding to the current ambient temperature based on the current ambient temperature comprises:
obtaining a common electrode compensation voltage corresponding to the current ambient temperature based on preset relationships of the current ambient temperature and different ambient temperatures with corresponding common electrode compensation voltages;
determining the compensated common electrode voltage corresponding to the current ambient temperature by compensating a common electrode voltage with the common electrode compensation voltage.

4. The voltage compensation method according to claim 1, that the step of determining a compensated common electrode voltage corresponding to the current ambient temperature based on the current ambient temperature comprises:
obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor;
obtaining a common electrode compensation voltage corresponding to the current ambient temperature based on the turn-on voltage of the thin film transistor and the turn-off voltage of the thin film transistor;
determining the compensated common electrode voltage corresponding to the current ambient temperature by compensating the common electrode voltage with the common electrode compensation voltage; or,
obtaining a turn-on voltage of a thin film transistor and a turn-off voltage of the thin film transistor corresponding to the current ambient temperature based on preset relationships of the current ambient temperature and different ambient temperatures with corresponding turn-on voltage of the thin film transistor and turn-off voltage of the thin film transistor;
determining the compensated common electrode voltage corresponding to the current ambient temperature based on the turn-on voltage of the thin film transistor and the turn-off voltage of the thin film transistor.

5. The voltage compensation method according to claim 4, wherein the step of obtaining a common electrode compensation voltage corresponding to the current ambient temperature based on the turn-on voltage of the thin film transistor and the turn-off voltage of the thin film transistor is:
obtaining the common electrode compensation voltage corresponding to the current ambient temperature based on preset relationships of the turn-on voltage of the thin film transistor and the turn-off voltage of the thin film transistor with the common electrode compensation voltage; or,
the step of determining the compensated common electrode voltage corresponding to the current ambient temperature based on the turn-on voltage of the thin film transistor and the turn-off voltage of the thin film transistor is:
determining the compensated common electrode voltage corresponding to the current ambient temperature based on preset relationships of the turn-on voltage of the thin film transistor and the turn-off voltage of the thin film transistor with the compensated common electrode voltage.

6. The voltage compensation method according to claim 1, wherein the method further comprises:
filtering the compensated common electrode voltage.

7. A voltage compensation device, comprising:
a first obtaining unit for obtaining a current ambient temperature;
a first determining unit for determining a compensated common electrode voltage corresponding to the current ambient temperature obtained by the first obtaining unit;
an output unit for outputting the compensated common electrode voltage.

8. The voltage compensation device according to claim 7, wherein the first determining unit is used for determining the compensated common electrode voltage corresponding to the current ambient temperature based on preset relationships of different ambient temperatures with corresponding compensated common electrode voltages.

9. The voltage compensation device according to claim 7, wherein the first determining unit comprises:
a first obtaining module for obtaining a common electrode compensation voltage corresponding to the current ambient temperature based on preset relationships of different ambient temperatures with corresponding common electrode compensation voltages;
a first determining module for determining the compensated common electrode voltage corresponding to the current ambient temperature by compensating a common electrode voltage with the common electrode compensation voltage.

10. The voltage compensation device according to claim 7, wherein the first determining unit comprises:
a second obtaining module for obtaining a turn-on voltage of a thin film transistor and a turn-off voltage of the thin film transistor corresponding to the current ambient temperature based on preset relationships of different ambient temperatures with corresponding turn-on voltage of the thin film transistor and turn-off voltage of the thin film transistor;
a third obtaining module for obtaining a common electrode compensation voltage corresponding to the current ambient temperature based on the turn-on voltage of the thin film transistor and the turn-off voltage of the thin film transistor;
a second determining module for determining the compensated common electrode voltage corresponding to the current ambient temperature by compensating the common electrode voltage with the common electrode compensation voltage;
or, the first determining unit comprises:
a fourth obtaining module for obtaining a turn-on voltage of a thin film transistor and a turn-off voltage of the thin film transistor corresponding to the current ambient temperature based on preset relationships of different ambient temperatures with corresponding turn-on voltage of the thin film transistor and turn-off voltage of the thin film transistor;
a third determining module for determining the compensated common electrode voltage corresponding to the current ambient temperature based on the turn-on voltage of the thin film transistor and the turn-off voltage of the thin film transistor.

11. The voltage compensation device according to claim 10, wherein,
the third obtaining module is used for obtaining the common electrode compensation voltage corresponding to the current ambient temperature based on preset relationships of the turn-on voltage of the thin film transistor and the turn-off voltage of the thin film transistor with the common electrode compensation voltage; or,
the third determining module is used for determining the compensated common electrode voltage corresponding to the current ambient temperature based on preset relationships of the turn-on voltage of the thin film transistor and the turn-off voltage of the thin film transistor with the compensated common electrode voltage.

12. The voltage compensation device according to claim 7, wherein the voltage compensation device further comprises:
a filtering unit for filtering the compensated common electrode voltage.

13. A display device, including a voltage compensation device, the voltage compensation device comprising:
a first obtaining unit for obtaining a current ambient temperature;
a first determining unit for determining a compensated common electrode voltage corresponding to the current ambient temperature obtained by the first obtaining unit;
an output unit for outputting the compensated common electrode voltage.

14. The display device according to claim 13, wherein the first determining unit is used for determining the compensated common electrode voltage corresponding to the current ambient temperature based on preset relationships of different ambient temperatures with corresponding compensated common electrode voltages.

15. The display device according to claim 13, wherein the first determining unit comprises:
a first obtaining module for obtaining a common electrode compensation voltage corresponding to the current ambient temperature based on preset relationships of different ambient temperatures with corresponding common electrode compensation voltages;
a first determining module for determining the compensated common electrode voltage corresponding to the current ambient temperature by compensating a common electrode voltage with the common electrode compensation voltage.

16. The display device according to claim 13, wherein the first determining unit comprises:
a second obtaining module for obtaining a turn-on voltage of a thin film transistor and a turn-off voltage of the thin film transistor corresponding to the current ambient temperature based on preset relationships of different ambient temperatures with corresponding turn-on voltage of the thin film transistor and turn-off voltage of the thin film transistor;
a third obtaining module for obtaining a common electrode compensation voltage corresponding to the current ambient temperature based on the turn-on voltage of the thin film transistor and the turn-off voltage of the thin film transistor;
a second determining module for determining the compensated common electrode voltage corresponding to the current ambient temperature by compensating the common electrode voltage with the common electrode compensation voltage;
or, the first determining unit comprises:
a fourth obtaining module for obtaining a turn-on voltage of a thin film transistor and a turn-off voltage of the thin film transistor corresponding to the current ambient temperature based on preset relationships of different ambient temperatures with corresponding turn-on voltage of the thin film transistor and turn-off voltage of the thin film transistor;
a third determining module for determining the compensated common electrode voltage corresponding to the current ambient temperature based on the turn-on voltage of the thin film transistor and the turn-off voltage of the thin film transistor.

17. The display device according to claim 16, wherein,
the third obtaining module is used for obtaining the common electrode compensation voltage corresponding to the current ambient temperature based on preset relationships of the turn-on voltage of the thin film transistor and the turn-off voltage of the thin film transistor with the common electrode compensation voltage; or,
the third determining module is used for determining the compensated common electrode voltage corresponding to the current ambient temperature based on preset relationships of the turn-on voltage of the thin film transistor and the turn-off voltage of the thin film transistor with the compensated common electrode voltage.

18. The display device according to claim 13, the voltage compensation device further comprises:
a filtering unit for filtering the compensated common electrode voltage.
